(19) United States
(12) Patent Application Publication
(10) Pub. No.: US 2004/0010957 A1
(43) Pub. Date: Jan. 22, 2004

(54) Wildlife decoy with moveable center of gravity

(76) Inventor: Richard L. Corbiere JR., N. Ferrisburgh, VT (US)

Correspondence Address: JAMES MARC LEAS, 37 BUTLER DRIVE, S. BURLINGTON, VT, 05403, US

(21) Appl. No.: 10/196,983

(22) Filed: Jul. 18, 2002

(51) Int. Cl. A01M 31/06

(52) U.S. Cl. 43/3

(57) ABSTRACT

An improved wildlife decoy, which includes an internal electromechanical device which when operated, moves the center of gravity of the decoy back and forth. As a result the decoy changes attitudes continuously between a normal upright sitting posture and a forward tipping feeding posture, which creates lifelike movement and ripples upon the water.

### BACKGROUND

1. Field of the Invention

The present invention relates to decoys used to attract wildlife, and more particularly to electromechanically animated waterfowl decoys.

2. Discussion of Prior Art

Originally waterfowl decoys were made to be stable when floating on the water, relying on wind or the water's current to make them appear lifelike. One of the problems has been that waterfowl have become very aware of the lack of motion in the flock of decoys on a calm sunny day and will shy away rendering the decoys useless. Recently decoy makers have tried to provide some form of motion on or around the decoys to create a more lifelike flock of decoys.

Decoy makers have made decoys that swim or are propelled through the water. These methods with external means of propulsion such as propellers or fins are prone to getting tangled in the marsh grasses where the birds live. Some have tried flapping or rotating the wings on a decoy to attract waterfowl but the constant flapping of the wings is not natural. Still others have made a half-decoy, using the back half only, to simulate a bird in a dabbling or feeding position, sometimes adding motors for vibrating the surrounding water and as with the others mentioned above, these are just supplemental decoys added to a flock of inanimate flat bottomed basic decoys.

U.S. Pat. No. 6,088,944 issued Jul. 18, 2000, discloses a decoy with an external floatation device which when filled with water tips the decoy into a vertical feeding position. The floatation device will hinder the full vertical deployment of the decoy in shallow water.

U.S. Pat. No. 5,775,022 issued Jul. 7, 1998, discloses a self-propelled decoy with an external fin used for propulsion and swims in a circular area determined by the anchor line.

U.S. Pat. No. 4,612,722 issued Sep. 23, 1986, discloses a motorized swimming decoy which when activated moves randomly in circular pattern in clear water with no vegetation to impede the propeller.

U.S. Pat. No. 5,930,936 issued Aug. 3, 1999 and U.S. Pat. No. 4,56,6214 issued Jan. 28, 1986 both discloses feeder decoys, which simulate the back half of a submerged duck, which is feeding on the bottom. The decoys consist of the tail half of the duck and may have a motor to create ripples in the water.

U.S. Pat. No. 6,212,816 B1 issued April 10, 2000, discloses a land type decoy with an oscillating mechanism used to impart a motion horizontal to the ground simulating a walking bird.

U.S. Pat. No. 5,926,990 issued Jul. 27, 1999, discloses a decoy movement system with a rod assembly and pivoting legs to simulate a feeding goose on land.

U.S. Pat. No. 5,636,466 issued Jun. 10, 1997, discloses a land decoy with leg retraction and extension assembly remotely controllable and with flapping appendages to imitate wings.

U.S. Pat. No. 6,070,356 issued Jun. 6, 2000, discloses an insertable movement device which when inserted into a decoy causes the decoy to vibrate in a somewhat lifelike manner.

U.S. Pat. No. 6,079,140 issued Jun. 27, 2000, discloses a motion system for multiple decoys wherein when activated the attached decoys are pulled beneath the water to simulate feeding ducks. This system uses a heavy frame to hold the decoys and a large battery to propel the water upwards.

U.S. Pat. No. 5,809,683 issued Sep. 22, 1998, discloses a motorized decoy with moving wings and feet. The decoy sits flatly on the surface of the water and utilizes wings that move back and forth.

U.S. Pat. No. 6,170,188 B1 issued Jan. 9, 2001, discloses a motorized decoy with rotating wings. The decoy is staked above the water with a metal pole to simulate a duck landing.

### SUMMARY

The present invention incorporates the movements needed to attract waterfowl with the internal mechanisms necessary to keep a full bodied decoy free of exterior entanglements, with the benefit of giving a lifelike appearance of both a resting or natural positioned bird and a feeding or dabbling bird.

### OBJECTS AND ADVANTAGES

Accordingly, several objects and advantages of my invention are:

1. To provide a full bodied decoy that moves from a natural sitting posture to a natural feeding posture by means of a fully internal electromechanical device.

2. To provide a decoy with a means for a back and forth weight transfer totally inside the housing.

3. To provide a decoy free of any external fins and propellers or floatation devices that would get tangled up in a naturally grassy marsh.

4. To provide a decoy that is a constant attractor without any external flapping appendages that are unnatural in real wildlife.

5. To provide a decoy that operates both in a static mode and an active mode and therefore eliminates the need for any additional attractor decoys.

6. To provide a decoy with a simple means of turning on or off.

7. To provide a decoy with a removable cover for easy access to the housing interior.

8. To provide a decoy with keels that functions on land as well as in water.

9. To provide a decoy that is lightweight and stake free.

Further objects and advantages of my invention will become apparent from a consideration of the drawings and ensuing descriptions.

### DRAWING FIGURES

FIG. 1 shows a side elevation view of the wildlife decoy with its normal center of gravity, sitting in an upright position on a body of water.

FIG. 2 shows a side elevation view of the wildlife decoy with a forward center of gravity, illustrating feeding in a tipping position on a body of water.

FIG. 3 shows a sectional view depicting the internal mechanism in a normal center of gravity position and the decoy in a normal sitting position.

FIG. 4 shows a sectional view depicting the internal mechanism in a forward center of gravity mode and the decoy in a feeding/tipping position.

FIG. 5A shows a perspective view of the cover and latch from below.

FIG. 5B shows a sectional side view of the cover and latch.

FIG. 5C shows a perspective view of the back half of the latch and cover when turned upside down.

FIG. 5D show a perspective view of the hold down strap and hinge pins.

FIG. 6A shows a perspective view of the rear base from behind.

FIG. 6B shows a perspective view of the front base and slide rods from behind.

FIG. 6C shows a perspective view of the rear base and one slide rod from below and forward.

FIG. 6D shows a perspective view of the slide rods and roll pins.

FIG. 6E shows a sectional view of the front base, slide rods and ball chain at the ball chain slot.

FIG. 6F shows a frontal perspective view of the front base with center slot for the slide rod and slots underneath for the ball chain as well as the roll pin used to hold the slide rod

FIG. 6G shows a cross sectional view of the front base with the roll pin holding the slide rod in place.

FIG. 7A shows a perspective view of the battery cover from above with the two posts used to hold the weight in place.

FIG. 7B shows a perspective view of the battery cover from below showing the two slots that hold it onto the sled.

FIG. 7C shows a perspective view of the sled from above with the battery cavity and the motor cavity with motor hold down tab

### REFERENCE NUMERALS IN DRAWINGS

| | | | |
|---|---|---|---|
| 10 | housing | 70 | switch |
| 20 | cover | 80 | keel |
| 25 | gasket | 90 | keel hole |
| 30 | latch | 100 | sled |
| 31 | latch screw | 105 | spring |
| 40 | front base | 110 | motor |
| 50 | rear base | 115 | cam |
| 55 | hold down strap | 117 | ball chain |
| 56 | hinge pins | 120 | battery |
| 60 | slide rods | 125 | battery cover |
| 61 | roll pin | 130 | weight |

### DESCRIPTION OF THE INVENTION

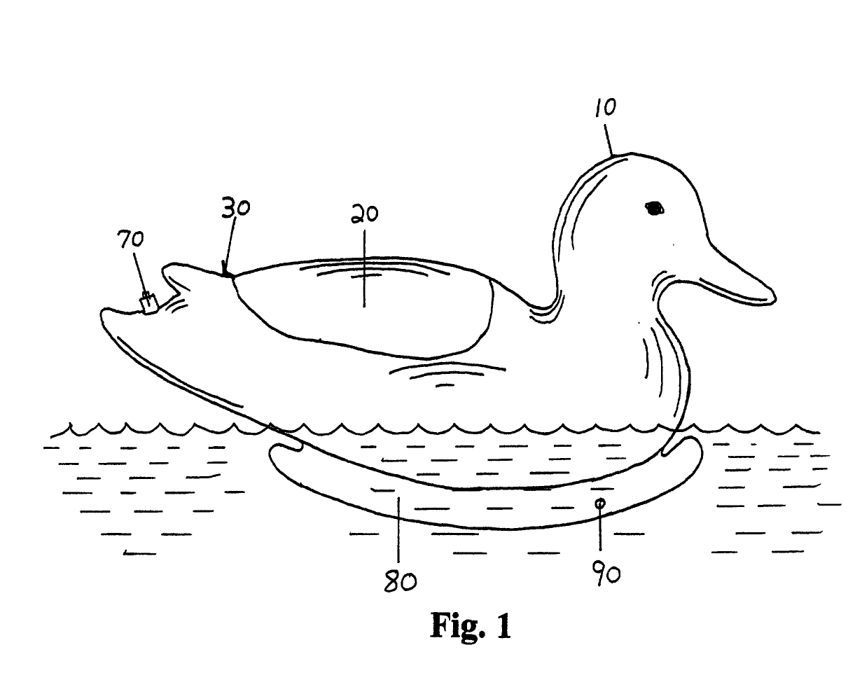

FIG. 1 shows an embodiment of the invention as a hollow bodied floatable waterfowl decoy in a sitting position, constructed of any suitable materials such as plastic, fiberglass or rubber. A decoy housing 10 having a configuration of a waterfowl's body and head with a rounded bottom. A removable cover 20 provides access to the interior of said housing and snaps into place by means of a latch 30. A keel 80 provides side-to-side stability and runs lengthwise front to back along the bottom portion of said housing 10 that is below the waterline when the decoy is in a sitting position. A keel hole 90 on said keel provides a means to attach a line and anchor. An external on/off switch 70 is located on top of the tail section of the decoy to provide a means of switching the power on/off.

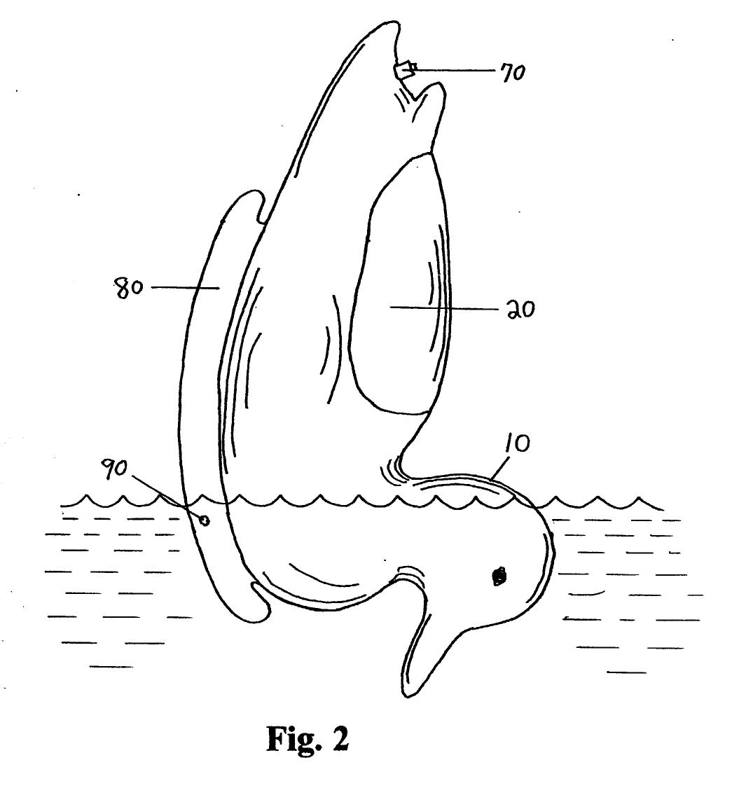

FIG. 2 shows said housing 10 in the feeding position where the keel hole 90 is below the waterline and the switch 70 and the cover 20 are above the waterline.

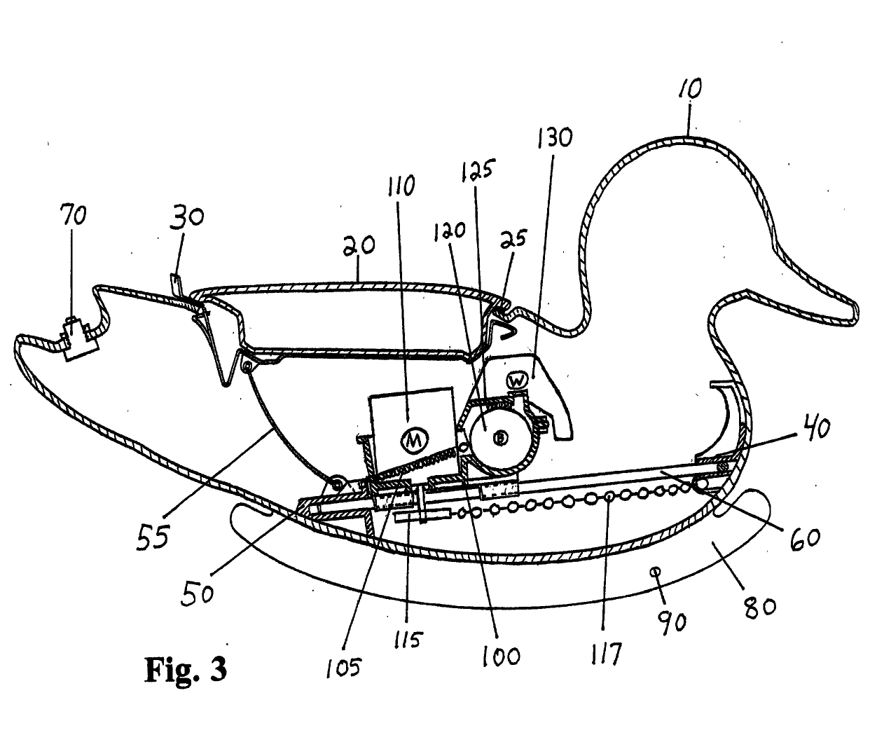

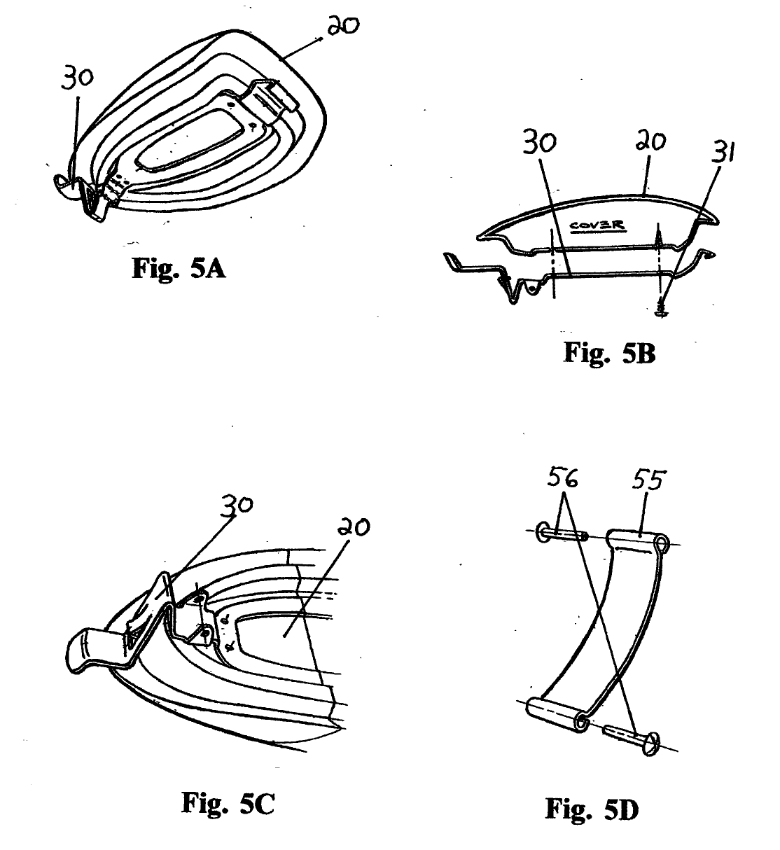

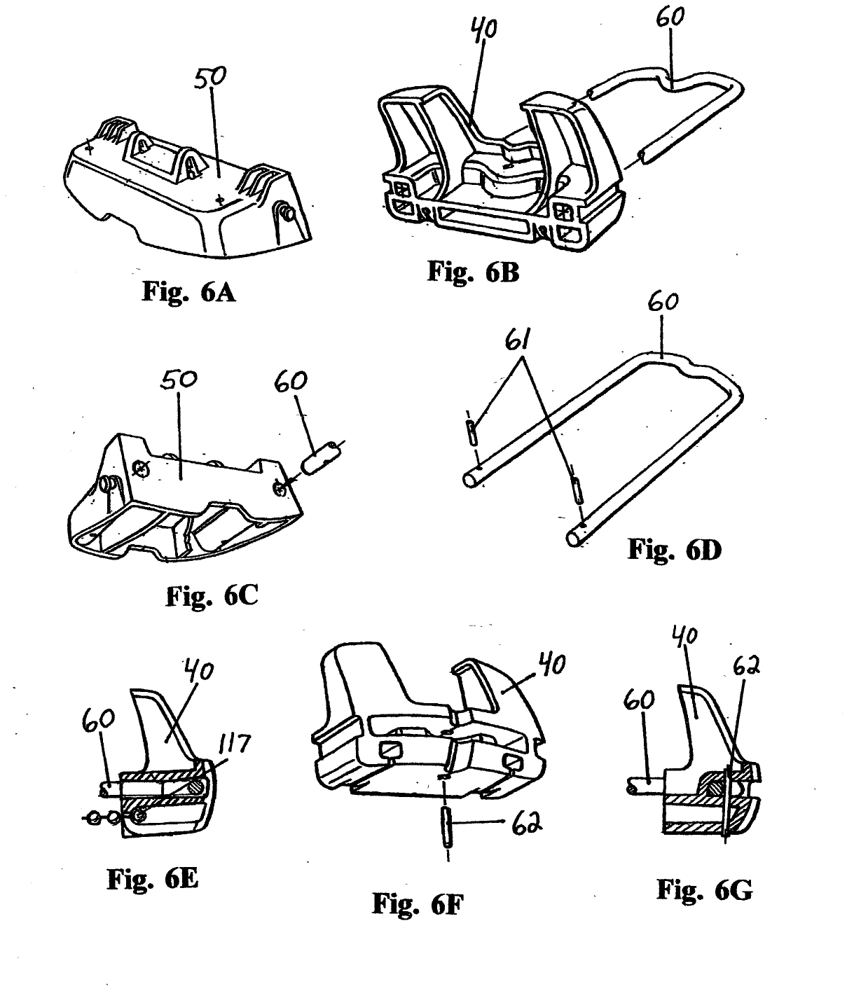

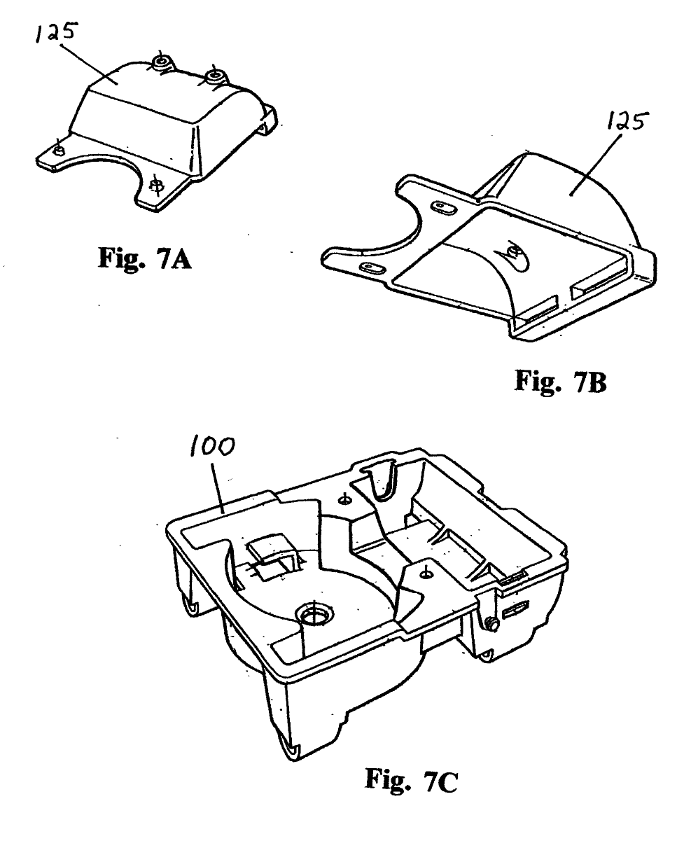

FIG. 3 shows the internal electromechanical system of the decoy in a resting position. It is best to break this down into three groups. First an exterior unit consisting of the housing 10, the cover 20 and the switch 70, second a base unit on which a sled 100 will slide consisting of a slide rod 60 which is held in place by a front base 40 and a rear base 50, and third said sled 100 which consists of a motor 110, a battery 120, a battery cover 125 and a weight 130. The housing 10 and cover 20 are blow molded plastic parts that imitate wildlife forms; this particular one represents a waterfowl. The cover 20 has a gasket 25 adhered to it for watertightness and is itself attached to the housing 10 by means of a latch 30 made of spring steel or a like material with the forward end formed to fit underneath the exterior housing 10 and the rearward end formed into a catch (see FIG. 5C) which when pressed down into the housing 10 springs backwards to catch the housing from below. Attached to the latch 30 is a hold down strap 55 with a hinge pin 56 (see FIG. 5D) also made of spring steel which puts downward pressure on said rear base 50 (see FIG. 6A) which in turn transfers that force through the slide rods 60 (see FIG. 6D) and forces the front base 40 into a friction fit with the housing 10. The slide rods 60 are run through and are pinned to the front base 40 (see FIGS. 6B, 6F, 6G) then pass through the sled 100 and into the rear base 50 where both ends are pinned (see FIGS. 6A, 6C). The motor 110 snaps into the sled 100 and its threaded shaft protrudes through and below the sled 100. The battery 120 is used to power the motor and fits into a formed compartment in the sled 100 (see FIG. 7C) then the battery cover 125 (see FIG. 7B) snaps over the end of the sled 100 and forms the attachment points for securing the weight 130 which can be made of lead or some other appropriate material. A stainless steel ball chain 117 is then attached to the front base 40 by means of a retaining slot (see FIG. 6E) and is pinned to a cam 115, which is threaded onto the shaft of said motor 110. A spring 105 is attached to both the sled 100 and the rear base 50 and is used to pull the sled 100 back to the resting position. The push button switch 70 used to activate the system is shown attached to the housing 10.

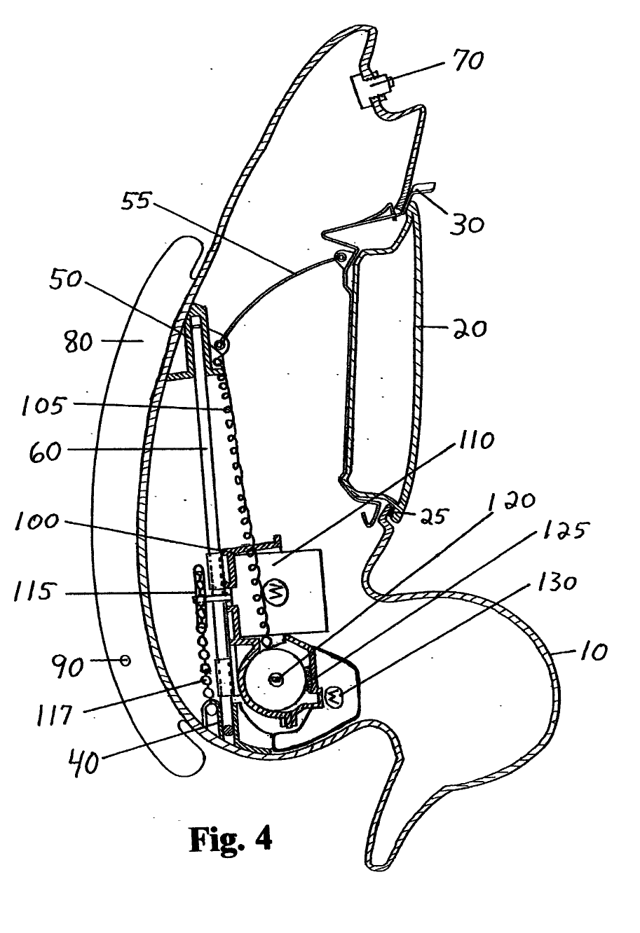

FIG. 4 shows the internal electromechanical system of the decoy in a tipping position. The ball chain 117 has wrapped around the cam 115 and pulled the sled 100 and it's components forward so that the weight 130 now touches the housing 10. The spring 105 is now extended and ready to pull the sled 100 back to the resting position.

FIG. 5B shows a side view of the latch 30 and how it is formed to the contour of the cover 20 and the preferred embodiment of using a latch screw 31 to attach the two parts together.

Operation of the Invention

The wildlife decoy with a moveable center of gravity enables a hunter, photographer or anyone interested in wildlife to attract any number of wildlife species to their immediate vicinity by using the internal forces of nature, the need for food and the need for safety with others. The wildlife decoy imitates the target animals' behavior while feeding and creates a vibrant field of ripples on the surrounding water, which in turn gives any surrounding decoys a lifelike appearance.

The hunter would place the waterfowl decoy as seen in FIG. 1 upon the water as any other standard decoy would be. The operation of the invention begins when in FIG. 3 the switch 70 is placed in the on position which activates an electrical circuit between the battery 120 and the motor 110 which in turn causes the motor's shaft and the attached cam 115 to rotate and wind the ball chain 117 around itself, and thereby pulling itself and the sled 100 with all it's components forward along the slide rods 60, at the same time extending the attached spring 105 until in FIG. 4 the weight 130 contacts the housing 10 and forces the decoy into the desired tipping position and creates rippling of the water.

Now that the weight 130 has contacted the housing 10 the continual pull of the motor 110 causes the ball chain 117 to slip off of the cam 115 which allows the spring 105 to contract, pulling the sled 100 and all of it's components backwards until they contact the rear base 50 as seen in FIG. 3 which causes the decoy to splash backwards creating more ripples that attract the wildlife and then the cycle starts over again and is repeated until the switch 70 is deactivated.

Conclusion, Ramifications and Scope

Accordingly, the reader will see that the wildlife decoy with moveable center of gravity provides a fully internal electromechanical device that is economical and highly reliable. This decoy can be used in icy waters or grassy marshes and remain free from the exterior entanglements that impede other decoys, yet it is lightweight and easily turned on and deployed by persons of any age who want to attract wildlife.

While my above description contains much specificity, they should not be construed as limitations on the scope of the invention, but rather as an exemplification of one preferred embodiment thereof. Many other variations and modifications may be made by those skilled in the art while keeping within the scope and spirit of the present invention, that aren't important enough to show in the drawings, for example;

In another embodiment, the center of gravity is transferred back and forth by means of a pendulum instead of sliding on rods.

In another embodiment the internal mechanism is attached to the housing by screws, rivets etc. . . .

In another embodiment the housing is molded to accept the internal mechanism.

In another embodiment the internal mechanism is made as a kit to retrofit existing decoys.

In another embodiment the center of gravity is transferred by means of a sled on wheels.

In another embodiment the latch is molded into the cover.

In another embodiment the cam would propel the sled by pushing against the base and therefore eliminating the need for the ball chain.

In another embodiment the sled is propelled by use of a scissor-jack assembly.

In another embodiment the sled is propelled by the use of magnets.

In another embodiment the slide rods are curved.

In another embodiment a trip lever is employed to return the sled.

In another embodiment the cam is replaced with a wheel.

Accordingly, it is intended to embrace all such alternatives, modifications and variations that fall within the spirit and scope of the following claims.

Accordingly, I claim:

1. An electromechanical wildlife decoy with a moveable center of gravity comprising of in combination:
(a) A floatable hollow body housing in the configuration of the targeted wildlife.
(b) A means for changing the center of gravity back and forth within said housing for the purpose of tipping the decoy forward into a feeding position, said means comprised of an electric motor, a battery, a weight means and a slide means.

2. The electromechanical wildlife decoy with a moveable center of gravity of claim 1 wherein said means for changing the center of gravity back and forth is comprised of an electric motor, a battery, a weight means and a pivot means.

3. The electromechanical wildlife decoy with a moveable center of gravity of claim 1 wherein a removable cover is provided on the top of said housing for access to the interior of said housing.

4. The electromechanical wildlife decoy with a moveable center of gravity of claim 1 wherein said housing is configured as a waterfowl in a sitting position above the surface of the water and configured with a rounded convex bottom below the surface of the water. A keel is vertically attached to said housing bottom running from front to back for the purpose of stability in the water and as a means of rocking back and forth on land. Said keel having a means to attach an anchor line.

5. The electromechanical wildlife decoy with a moveable center of gravity of claim 1 wherein a sled comprised of said motor, said battery and said weight is disposed within said housing.

6. The electromechanical wildlife decoy with a moveable center of gravity of claim 1 wherein an electric circuit means is comprised of said motor, said battery and an on-off switch, said switch is disposed on the exterior of said housing.
Whereby this decoy can tip forward to a feeding position and then return to a resting position.
